(19) United States
(12) Patent Application Publication
(10) Pub. No.: US 2007/0131906 A1
(43) Pub. Date: Jun. 14, 2007

(54) Rare-earth phosphate colloidal dispersion, method for the production thereof and a transparent luminescent material obtainable from said dispersion

(76) Inventors: Jean-Pierre Boilot, Meudon La Foret (FR); Valerie Buissette, Clichy (FR); Jean-Yves Chane-Ching, Eaubonne (FR); Thierry Gacoin, Bures-Sur-Yvette (FR); Thierry Le-Mercier, Paris (FR)

Correspondence Address: Jean Louis Seugnet;Rhodia Inc, Legal Department CN 7500, 8 Cedar Brook Drive, Cranbury, NJ, 08512-7500, US

(21) Appl. No.: 10/572,299

(22) PCT Filed: Sep. 15, 2004
(86) PCT No.: PCT/FR04/02340

§ 371 Date: Jan. 29, 2007

(30) Foreign Application Priority Data
Sep. 18, 2003 (FR) 0310968

(51) Int. Cl. C09K 11/08; C09K 11/77; C09K 11/68; C09K 11/70; B01F 3/12; B01F 17/00

(52) U.S. Cl. 252/301.4 P; 252/301.5; 252/301.4 R; 977/811; 428/690; 516/89

(57) ABSTRACT

The invention relates to a colloidal dispersion comprising rhabdophane-structured rare-earth phosphate particles (Ln) and a polyphosphate. Said dispersion is prepared by a method consisting in forming a medium comprising at least one type of rare-earth salt and a poly phosphate in such quantities that the P/Ln ratio is equal to or higher than 3, in heating the thus obtained medium and in removing residual salts, thereby obtaining said dispersion. Said invention also relates to a transparent luminescent material which is obtainable from said dispersion and based on the rare-earth phosphate particles and a polyphosphate and whose P/Ln ratio is higher than 1, to a luminescent system comprising said material and to an excitation source.

The present invention relates to a colloidal dispersion of a rare-earth phosphate, to its method of production and to a transparent luminescent material that can be obtained in particular from this dispersion.

Rare-earth phosphates are known for their luminescence properties. They are also used, in colloidal dispersion form, in the electronics industry as polishing agents.

At the present time, there is considerable development in the fields of luminescence and electronics. Examples of these developments that may be mentioned include the development of plasma systems (for displays and lamps) for the latest display and illumination technologies. These new applications require phosphor materials having better and better properties. Thus, apart from their luminescence property, specific morphology or particle-size characteristics are required of these materials, in particular so as to make them easier to use in the desired applications.

More precisely, it is required to have phosphors in the form of particles that are as far as possible individual particles of very small size.

Moreover, and again within the context of the development in the fields of luminescence and electronics, the aim is to obtain materials in the form of films that are transparent and able to emit in various colors, but also in the white.

Sols or colloidal dispersions may provide a useful way of obtaining such a type of product.

A first object of the invention is to provide a rare-earth phosphate in the form of a colloidal dispersion.

A second object of the invention is to obtain a luminescent material of the above type.

For this purpose, the colloidal dispersion of the invention is characterized in that it comprises particles of a rare-earth (Ln) phosphate of rhabdophane structure and in that it further includes a polyphosphate.

The invention also relates to a transparent luminescent material according to a first embodiment, based on particles of a rare-earth (Ln) phosphate, in which material the P/Ln molar ratio is greater than 1.

The invention also relates to a transparent luminescent material according to a second embodiment, which is characterized in that it comprises nanoparticles of compounds chosen from vanadates, rare-earth phosphates, tungstates and rare-earth oxides and in that it is capable of emitting, when it is subjected to excitation, a white light whose trichromatic coordinates lie within the following polyhedron in the CIE chromaticity diagram: (x=0.16; y=0.10); (x=0.16; y=0.4); (x=0.51; y=0.29); (x=0.45; y=0.42).

Other features, details and advantages of the invention will become more fully apparent on reading the description that follows, and also from the various specific but nonlimiting examples intended to illustrate it.

The term rare earth (Ln) or lanthanide is understood to mean the elements of the group consisting of yttrium and the elements of the Periodic Table with atomic numbers from 57 to 71 inclusive.

Unless otherwise indicated, in the rest of the description the values of the limits in the ranges of values given are inclusive.

The invention applies to dispersions or sols of particles of phosphates of one or more rare earths. These are understood here to be particles essentially based on orthophosphates, generally hydrated orthophosphates of formula LnPO₄.nH₂O, Ln denoting one or more rare earths and n usually being between 0 and 1, more particularly between 0 and 0.5, it being possible for n to be even more particularly equal to 0.5.

Moreover, for the rest of the description, the expression “colloidal dispersion or sol of a rare-earth phosphate” denotes any system consisting of fine solid particles of colloidal dimensions generally based on a rare-earth phosphate within the meaning given above, which may be hydrated and in suspension in a liquid phase. These particles may also, optionally, contain residual amounts of bonded or adsorbed ions that may come from the rare-earth salts used to produce the dispersion, such as for example nitrate, acetate, chloride, citrate or ammonium anions, or sodium ions or even phosphate anions (HPO₄²⁻, PO₄³⁻, P₃O₁₀⁵⁻, etc.). In such dispersions, it should be noted that the rare earth may be either completely in the form of colloids or simultaneously in the form of ions, complexed ions and colloids. Preferably, at least 80%, or even 100%, of the rare earth is in colloidal form.

The phosphate has a rhabdophane structure (hexagonal structure: P6₂22 group (number 180); JCPDS File 46-1439).

The size of the crystallites, determined by X-ray diffraction on particle powders using the Scherrer method, is generally less than 30 nm, more particularly less than 20 nm, preferably less than 10 nm and even more preferably at most 8 nm.

The dispersions of the invention are nanoscale dispersions. By this is meant dispersions whose colloids generally have a size of at most about 250 nm, especially at most 100 nm, preferably at most 20 nm and even more particularly at most 15 nm. The colloidal particles may especially have a size of between about 5 nm and about 20 nm.

The aforementioned sizes correspond to mean hydrodynamic diameters as determined by quasi-elastic light scattering using the method described by Michael L. McConnell in the journal Analytical Chemistry 53(8), 1007 A (1981).

Furthermore, in a preferred embodiment, the colloidal particles are isotropic or substantially isotropic as regards their morphology. This is because their form approaches that of a sphere (with a completely isotropic morphology) as opposed to particles of acicular or platelet form.

More precisely, the particles may have an L/1 ratio of at most 5, preferably at most 4 and even more particularly at most 3, L denoting the greatest length of the particle and 1 denoting the shortest length.

The present invention applies most particularly to the case in which the rare earth is lanthanum, cerium, europium, gadolinium, terbium, lutecium or yttrium.

Moreover, as indicated above, the phosphates of the invention may comprise several rare earths, most particularly in the case in which the phosphates have to have luminescence properties. In this case, the phosphates comprise a first rare earth, which may be considered as a constituent element of the orthophosphate, and one or more other rare earths, usually denoted by the term “dopant”, which is or are the origin of these luminescence properties. The minimum amount of dopant is the amount needed to obtain said properties.

Thus, the invention applies in particular to colloidal dispersions of lanthanum cerium terbium ternary phosphates. Among these ternary phosphates, mention may more particularly be made of those of formula LaₓCe_{y}Tb_{1-x-y}PO₄ in which x is between 0.4 and 0.7 inclusive and x+y is greater than 0.7.

The invention also applies in particular to lanthanum europium or lanthanum thulium or lanthanum thulium gadolinium mixed phosphates. In the case of phosphates containing thulium, the thulium content, expressed in at % relative to lanthanum, may be especially between 0.1 and 10, more particularly between 0.5 and 5 and for those containing gadolinium, the content of the latter element, expressed in at % relative to lanthanum, may for example vary between 10 and 40%.

The invention also applies to lanthanum cerium phosphates and lanthanum dysprosium phosphates. In the case of lanthanum cerium phosphates, the cerium content may be more particularly between 20% and 50%, the content expressed in at % of cerium relative to the sum of the cerium and lanthanum atoms.

When the phosphate contains cerium, most particularly in the case of a phosphate exhibiting luminescence properties, the cerium is in the form of cerium III in respect of at least 90%, preferably at least 95%, of the total cerium.

According to another feature, the dispersion of the invention further includes a polyphosphate. The term “polyphosphate” is understood in the present description to mean a compound whose structure consists of an assembly of PO₄³⁻ tetrahedra, it being possible for these tetrahedra to be assembled either as linear chains in the form: 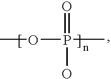
n being at least equal to 2, or else as ring compounds, by these chains closing up on themselves so as to form cyclic metaphosphates.

The polyphosphates described above may especially correspond to, or be derived from, phosphates of monovalent, divalent or trivalent metals, and particularly alkali metals. These phosphates may be compounds satisfying in particular the formula (1): 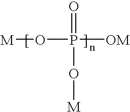
or Mₙ₊₂PₙO₃ₙ₊₁ in the case of linear compounds, or (MPO₃)m in the case of cyclic compounds, in which formulae M represents a monovalent metal, it also being possible for OM to be replaced with an organic group and at least one of the Ms replaced with hydrogen.

Examples of polyphosphates that may be mentioned include tripolyphosphates (n=3), which in particular result from compounds of formula (1), and hexametaphosphates, which result from (MPO₃)₆, compounds in which M is an alkali metal, in particular sodium. Mention may also be made of adenosine triphosphate C₁₀H₆O₁₃N₅P₃.

The presence of a polyphosphate of the above type may be demonstrated by ³¹P phosphorus MAS NMR at 15 kHz on a particle powder. The NMR spectrum shows the presence of a first peak corresponding to a chemical shift that can be assigned to the constituent orthophosphate of the particles and at least two other peaks corresponding to chemical shifts that can be assigned to the polyphosphate compound. These chemical shifts depend strongly on the polyphosphate/rare earth ratio and on the pH.

In addition, the width of these polyphosphate peaks suggests the presence of this polyphosphate on the surface of the particles and bonded to the latter, probably by complexation and in anionic form. The liquid phase of the dispersion may possibly also comprise some polyphosphate, but in a small amount compared with the amount of polyphosphate bonded to the particles.

Owing to the presence of the polyphosphate, the phosphate particles of the dispersions of the invention have a P/Ln molar ratio of greater than 1. This ratio may be at least 1.1, especially at least 1.2 and even more particularly at least 1.5. For example, it may be between 1.1 and 2.

The dispersions according to the invention are generally aqueous dispersions, the water being the continuous phase. However, in certain variants, the dispersions of the invention may have an aqueous alcoholic continuous phase based on a water/alcohol mixture, an alcoholic continuous phase, or else a continuous phase consisting of an organic solvent. Possible alcohols that may be mentioned include methanol, ethanol and propanol.

The dispersions of the invention may have a concentration that varies over a wide range. This concentration may be at least 20 g/l, more particularly at least 50 g/l and even more particularly at least 100 g/l. This concentration is expressed by weight of particles. It is determined from a given volume of dispersion, after it has been dried and calcined in air.

The dispersions of the invention may have a pH that may for example be between 5 and 9.

The colloidal dispersions of the invention may also be in the form of various alternative embodiments that are described below.

The first alternative embodiment relates to dispersions that comprise particles of a phosphate of at least two rare earths (Ln, Ln′), a rare-earth (Ln) phosphate and a polyphosphate on the surface of these particles, this order of arrangement in the direction from the particle outward being preferred. This alternative embodiment applies most particularly to the luminescent phosphates described above, comprising two rare earths, one of which (Ln) is a constituent element of the orthophosphate (Ln may especially be lanthanum) and the other of which, (Ln′), is present as a dopant (Ln′ may especially be cerium and/or terbium). In the case of this alternative embodiment, the P/Ln molar ratio of the particles is as given above, that is to say greater than 1 and for example between 1.1 and 2.

This alternative embodiment provides particles that have a core/shell structure, or a structure similar to the latter, in which the core consists of the phosphate of at least two rare earths (Ln, Ln′) and the shell consists of the rare-earth (Ln) phosphate. This same alternative embodiment is especially beneficial for chemically stabilizing the dopant when this is necessary. For example, in the case of cerium, this alternative embodiment allows the cerium to be stabilized in the III form. Finally, it should be noted that this alternative embodiment may be employed with, as shell, a phosphate of two rare earths, Ln, Ln″, instead of the simple Ln phosphate.

The second alternative embodiment relates to dispersions that comprise a silica-based compound on the surface of the rare-earth phosphate particles. The expression “silica-based compound” is understood to mean a silicate or a mixture of a silicate and silica (SiO₂).

This second alternative embodiment also provides particles having a core/shell structure, in which the core consists of the rare-earth phosphate and the shell consists of the layer of silica-based compound.

A third alternative embodiment is possible, which derives from the second. In the case of this third alternative embodiment, the dispersion includes, in addition to the aforementioned silica-based compound, an organosiloxane-type polymeric compound on the surface of the rare-earth phosphate particles. The expression “organosiloxane-type polymeric compound” is understood to mean a product deriving from the polymerization-of an organosilane-type compound of formula RₓSi(OR′)₄₋ₓ, where R and R′ denote organic groups, more particularly alkyl, methacrylate or epoxy groups, R may also denote hydrogen.

It may be pointed out that, in the case of the second and third alternative embodiments, the pH of the dispersion, in the case of an aqueous dispersion, may be between 8 and 10.

The second and third alternative embodiments have in particular the advantage of improving the mutual compatibility of the dispersions, that is to say they make it possible to form mixtures of dispersions according to the invention and to obtain a novel stable colloidal mixed dispersion. Furthermore, the dispersions according to these two alternative embodiments may most particularly be in an alcoholic or aqueous alcoholic phase or in a solvent phase. In the latter case, solvents that may be mentioned include DMF, THF and DMSO.

Of course, the alternative embodiments that have been described above may be combined with one another. Thus, the particles of the dispersions of the invention may comprise, on the surface, a rare-earth phosphate and a silica-based compound, this order of arrangement in the direction from the particle toward the outside being preferred, optionally combined with an organosiloxane-type polymeric compound.

The dispersions according to the invention are stable and, depending on the nature of the phosphate, may be luminescent when they are exposed to an excitation. By excitation is meant here photon excitation with a wavelength of at most 380 nm, especially between 140 nm and 380 nm and more particularly between 200 nm and 380 nm. They emit in colors that depend on the composition of the phosphate. Thus, those based on lanthanum cerium phosphate emit partly in the blue, those based on lanthanum cerium terbium phosphate partly in the green, those based on lanthanum europium phosphate partly in the red, and those based on lanthanum dysprosium phosphate in the yellow.

These dispersions are also transparent.

The transparency is characterized by the transmission T through the medium in question (T being the ratio of the transmitted intensity to the incident intensity in the visible range, between 380 and 770 nm). The transmission is measured directly by the UV-visible spectroscopy technique using specimens whose volume fraction cᵥ of particles in the medium is at least 1% (cᵥ being the ratio of the volume occupied by the particles [phosphate particles with the polyphosphate and optionally the silica-based compound and the polymeric compound] to the total volume).

Under these experimental conditions, the dispersions of the invention and the films have a transmission for a thickness of one micron of at least 95% and preferably at least 99%.

The transmission T is related to the absorption coefficient εᵥ expressed in cm⁻¹ by the formula:
−log₁₀T=εᵥtcᵥ
where t is the thickness of the specimen expressed in cm. Under the above experimental conditions, the dispersions of the invention and the films thus have an absorption coefficient of at most 160 cm⁻¹ and preferably at most 40 cm⁻¹.

The method of producing the dispersions of the invention will now be described.

This method is characterized in that it comprises the following steps:
a mixture comprising at least one rare-earth salt and a polyphosphate is formed in quantities such that the P/Ln ratio is at least 3;
the mixture thus obtained is heated; and
the residual salts whereby a dispersion is obtained are removed.

The rare-earth salts may be salts of inorganic or organic acids, for example of the sulfate, nitrate, chloride or acetate type. It should be noted that nitrates and acetates are particularly suitable. As cerium salts, cerium III salts may more particularly be used, such as cerium III acetate, cerium III chloride and cerium III nitrate, and also mixtures of these salts, such as mixed acetate/chloride salts.

As indicated above, the polyphosphate employed in this first step of the method may more particularly be a tripolyphosphate, especially an alkali metal tripolyphosphate and more particularly a sodium tripolyphosphate.

The mixture is generally an aqueous mixture.

In the reaction mixture, the P/Ln molar ratio (where Ln denotes all of the rare earths present in the mixture) must be at least 3. A lower ratio does not allow a stable dispersion to be obtained. The upper limit of this ratio is less critical—it may for example be set at 6.

Preferably, the reaction mixture is formed by introducing the polyphosphate into the solution of the rare-earth salt(s).

The next step of the method is a heating step. The heating time is about 2 to 10 hours, more particularly 2 to 5 hours.

The heating temperature is generally between 60° C. and 120° C., more particularly between 60° C. and 100° C.

The time and the temperature are chosen so as to have good crystallization of the particles.

After the heating, a purification step is carried out in which the residual salts are removed from the reaction mixture. The term “residual salts” is understood to mean the cations associated with the polyphosphate, the excess polyphosphate and the rare-earth salts.

This purification may be carried out by centrifuging the dispersion and then washing the solid product obtained after the -centrifugation with demineralized water. The washed solid is then resuspended in water.

This purification may also be performed by ultrafiltration or dialysis.

The purification is carried out until a P/Ln molar ratio of at most 2 is obtained, this ratio being measured on the colloids obtained after the dispersion has been evaporated. After purification, a dispersion according to the invention is obtained.

This dispersion may if necessary be concentrated.

The concentration may be performed by ultrafiltration, by low-vacuum heating or by evaporation.

According to one particular way of implementing the method that has just been described, it is possible, after the step of removing the residual salts, to add, to the dispersion obtained, a second polyphosphate, preferably a polyphosphate of longer chain length than that of the polyphosphate used during the first step of the method. After this second polyphosphate has been added, the residual salts are then removed. What was described above in respect of that operation also applies here. For example, the second polyphosphate may be an alkali metal hexametaphosphate, such as sodium hexametaphosphate. The amount of second polyphosphate added is generally between 0.05 and 1, expressed as the polyphosphate/Ln molar ratio.

This particular implementation of the method makes it possible to obtain dispersions that are more concentrated and more stable.

The production of a dispersion according to the first alternative embodiment described above may start with a dispersion as obtained according to the method given above, to which a polyphosphate is added. The mixture obtained is then heated. The heating temperature is generally between 40° C. and 80° C. In a next step, a salt of the rare earth Ln is added to the reaction mixture in amounts such that the P/Ln molar ratio is at least 3 and preferably 6, Ln denoting here the constituent rare earth of the orthophosphate. This addition is preferably performed slowly.

After this addition, the mixture obtained is heated a second time under the same conditions as those given above in the description of the general way of implementing the method, namely in particular in a temperature range from 60° C. to 120° C. After this heating, the procedure is also as described above, the residual salts being removed and the dispersion concentrated if necessary.

As regards the production of a dispersion according to the second alternative embodiment described above, the method comprising the following steps may be implemented:
a silicate is added to a starting dispersion as obtained by the methods described above;
the mixture thus obtained undergoes a maturing step; and
the residual salts are removed.

It should be noted that it is possible to use as starting dispersion a dispersion according to the first alternative embodiment, and therefore as obtained by the method just described above in regard to this first alternative embodiment.

Preferably, the method is carried out by adding the dispersion to the silicate.

As silicate, an alkali metal silicate, for example a sodium silicate, may be used. Mention may also be made of tetramethylammonium silicate. The amount of silicate introduced is generally from 2 to 20 equivalents of Si relative to the total Ln ions.

The maturing step is generally carried out at room temperature, preferably with stirring. The duration of the maturing step may for example be between 10 hours and 25 hours.

After the maturing step, the residual salts are removed. The term “residual salts” is understood to mean the silicate or the other salts in excess. This removal may be performed for example by dialysis of the mixture resulting from the maturing step or else by ultracentrifugation or ultrafiltration. This purification operation may be carried out until a pH value of for example at most 9 is obtained.

The dispersions according to the third alternative embodiment may be obtained from dispersions according to the second alternative embodiment and therefore as obtained by the method just described above with regard to this second alternative embodiment. Thus, a dispersion of this type is added to an organosilane-type compound as described above. This compound is normally used in the form of a solution in an alcohol. The mixture obtained is matured in a second step. This maturing generally takes place at a temperature of at least 40° C., for example between 40° C. and 100° C. It may be carried out by heating the mixture at reflux. Finally, it is possible to carry out a distillation so as to remove the water in the case of the presence of an alcohol provided with the solution of the organosilane compound.

To obtain a dispersion in an aqueous alcoholic phase, the desired alcohol may be added to the aqueous dispersion as obtained by the method relating to the second alternative embodiment. The method in the case of the third alternative embodiment as described above also makes it possible to obtain an aqueous alcoholic dispersion. In these cases, the distillation makes it possible to obtain a continuous phase based on a single alcohol. Finally, it is possible to add an organic solvent of the type described above (DMF, THF, DMSO) to the alcohol phase and then to remove the alcohol by distillation.

The invention also relates to a transparent luminescent material according to the first embodiment defined above, that is to say a material based on a phosphate and a material in which the P/Ln molar ratio is greater than 1, which can be obtained in particular from a dispersion according to the invention.

This material may be in two forms, that is to say either in bulk form, all of the material having the transparency and luminescence properties, or in composite form, that is to say in this case in the form of a substrate and of a layer on this substrate, the layer alone then having these transparency and luminescence properties. In this case too, the rare-earth phosphate particles are contained in said layer.

The substrate for the material is a substrate that may be made of silicon, based on a silicone, or made of quartz. This may also be a glass or a polymer such as polycarbonate. The substrate, for example the polymer, may be in the form of a rigid sheet or plate a few millimeters in thickness. It may also be in the form of a film from a few tens of microns or even a few microns to a few tenths of a millimeter in thickness.

The rare-earth phosphate particles have most of the characteristics, especially size, which were given above in the description of the dispersions. Thus, these are orthophosphate nanoparticles, therefore having a size of at most about 250 nm, especially at most 100 nm, preferably at most 20 nm and even more particularly at most 15 nm. The particles may especially have a size of between about 5 nm and about 20 nm. These values are obtained here by XR diffraction analysis or by transmission electron microscopy on the bulk material or on the layer.

These phosphate particles also have a P/Ln molar ratio of greater than 1, and in particular between 1.1 and 2. Likewise, the particles again may have the characteristics relating to the various alternative embodiments that were described above in regard to the dispersions. Thus, the particles may have, on the surface, a rare-earth phosphate that may more particularly be a lanthanum phosphate, a silica-based compound with, optionally, an organosiloxane-type polymeric compound.

As material according to the invention, mention may more particularly be made of that comprising lanthanum cerium phosphate particles and lanthanum cerium terbium phosphate particles.

The material, and more particularly the aforementioned layer, may further include binders or fillers of the silicate type, silica, phosphate or titanium oxide beads, or other mineral fillers for improving in particular the mechanical and optical properties of the material.

The thickness of the layer may be between 30 nm and 10 μm, preferably between 100 nm and 3 μm.

The material of the invention is transparent. This transparency is measured by the absorption coefficient as defined above with regard to the dispersions, the volume fraction cᵥ being that of the layer in a composite and being calculated in the case of the particles excluding binder or filler. The material of the invention, or the layer in the case of a composite, thus has an absorption coefficient of at most 160 cm⁻¹ and preferably at most 40 cm⁻¹. Finally, the material is luminescent under the excitation conditions given above.

The material, in its composite form, may be obtained by depositing a colloidal dispersion of the invention on the substrate, the substrate possibly being washed beforehand, for example using a sulfochromic mixture. The abovementioned binders or fillers may also be added during this deposition. This deposition may be carried out using a coating technique, for example spin coating or dip coating. After the layer has been deposited, the substrate is dried in air and then it may optionally be subjected to a heat treatment. The heat treatment is carried out by heating to a temperature generally of at least 200° C., the upper value of which is set in particular by taking into account the compatibility of the layer with the substrate so as in particular to avoid side reactions. The drying and the heat treatment may be carried out in air, in an inert atmosphere, in a vacuum or in hydrogen.

It should be noted that it is possible to produce materials having several superposed layers, for example each containing a phosphate of a different rare earth, by successive deposition of each of the layers.

It was seen above that the material may include binders or fillers. In this case it is possible to use dispersions that themselves contain at least one of these binders or fillers, or else precursors thereof. The invention therefore also covers the colloidal dispersions as described above, which furthermore contain this type of product. For example, tetramethylammonium silicate lithium silicate or, hexametaphosphate can be added, as binder, to the dispersions.

The material in bulk form may be obtained by incorporating the phosphate particles into a matrix of the polymer type for example, such as polycarbonate, polymethacrylate or a silicone.

The material, and more particularly the aforementioned layer, may comprise, apart from the phosphate particles, a polyphosphate as defined above. The presence of this polyphosphate depends on the method of producing the material. Thus, the materials obtained by carrying out only a drying step and not followed by a heat treatment or having undergone only a heat treatment at low temperature, may contain a polyphosphate. Likewise, the structure of the phosphate of the particles, namely a rhabdophane structure, apply only in the case of materials that have not undergone a heat treatment or only a treatment at low temperature.

As indicated above, the invention also relates to a transparent luminescent material according to a second embodiment. The following part of the description relates more particularly to this material according to this second embodiment and the means needed to manufacture it.

It should be noted here that what was stated above in respect of the two possible forms of the material, namely bulk form and composite form, also apply here to the material in this second embodiment. In the case of the material in composite form, the transmission conditions apply to the layer, and it is the layer that emits the light of the aforementioned coordinates when it is exposed to an excitation. The excitation in question here is as defined above, namely photon excitation with a wavelength of at most 380 nm, especially between 200 nm and 380 nm.

This material has the essential feature of being both transparent and emitting in the white.

The transparency, measured as indicated above in the case of the material according to the first embodiment, is such that the material, or the layer in the case of a composite, thus has an absorption coefficient of at most 160 cm⁻¹ and preferably at most 40 cm⁻¹.

It also emits, under the excitation conditions mentioned above, a white light whose trichromatic coordinates were given above.

The trichromatic coordinates of this white light may especially lie within the polyhedron defined by the following points: (x=0.20; y=0.15); (x=0.20; y=0.30); (x=0.49; y=0.32); (x=0.45; y=0.42).

More particularly, these coordinates may lie within the polyhedron defined by (x=0.22; y=0.18); (x=0.22; y=0.31); (x=0.47; y=0.49); (x=0.45; y=0.42).

Even more particularly, the trichromatic coordinates of this light may be equal to those of the curve called the BBL (black body locus). In this case, the material of the invention makes it possible more particularly to obtain emission color temperatures lying between 2700 and 8000 K, corresponding to the emission of white light as perceived by the human eye.

The definition and the calculation of the trichromatic coordinates and those of the BBL are given in several articles including “Fluorescent Lamp Phosphors” by K. H. Burter, The Pennsylvania State University Press, 1980, pages 98-107 and “Luminescent Materials” by G. Blasse, Springer-Verlag, 1994, pages 109-110.

As another feature, the material of the second embodiment comprises nanoparticles of compounds chosen from vanadates, rare-earth phosphates, tungstates and rare-earth oxides. These compounds must of course have luminescence properties under the excitation defined above and must be chosen according to the chromatic coordinates of the light that will be emitted by the material. As vanadate, it is possible to choose yttrium europium vanadate. As tungstate, mention may be made of zinc and calcium tungstates. The phosphates may be chosen from lanthanum cerium phosphate and lanthanum cerium terbium phosphate. Thus, the invention relates more particularly to a material comprising lanthanum cerium phosphate particles, lanthanum cerium terbium phosphate particles and yttrium europium vanadate particles.

The term “nanoscale” is understood here to mean the same size values as those given above, namely a size of at most about 250 nm, especially at most 100 nm, preferably at most 20 nm and even more particularly at most 15 nm and which, for example, may be between about 5 nm and about 20 nm. These values are obtained using the methods described in the case of the material according to the first embodiment.

In the particular case of a material according to this second embodiment and comprising at least one rare-earth phosphate, the phosphate particles have a P/Ln molar ratio of greater than 1. This ratio may be at least 1.1, especially at least 1.2 and even more particularly at least 1.5. For example, it may be between 1.1 and 2.

When particles of a phosphate of at least two rare earths (Ln, Ln′) are present, these phosphate particles may further include, on the surface, a rare-earth (Ln) phosphate, which may more particularly be a lanthanum phosphate.

Moreover, the phosphate particles may also include a silica-based compound on the surface, optionally with an organosiloxane-type polymeric compound, and they may have a rhabdophane structure as indicated in the case of the material according to the first embodiment, depending on the method of preparation.

The other features described above in the case of the material according to the first embodiment, especially as regards the substrate, also apply here.

To produce the material according to the second embodiment, a colloidal dispersion may be used such as that described above, which comprises lanthanum cerium phosphate particles and lanthanum cerium terbium phosphate particles. However, this dispersion also contains yttrium europium vanadate particles.

This specific dispersion may be obtained by mixing a dispersion according to the invention with a colloidal yttrium europium vanadate dispersion. The definitions given above for the term “colloidal dispersion” as regards phosphate dispersions also apply here in the case of the vanadate dispersion. Likewise, the vanadate dispersion may have the same size and morphology characteristics as those of the phosphate dispersions.

Thus, and preferably, the particles have a size of the same order of magnitude as those given above for the phosphate dispersions. More particularly, this size may be between about 2 nm and about 15 nm.

Colloidal yttrium vanadate dispersions are known.

They may be produced in particular from a mixture of yttrium europium salts and a complexing agent. This complexing agent may especially be chosen from polyacid-alcohols or their salts. For example, mention may be made of malic acid and citric acid. The mixture is heated and after heating what is obtained is a colloidal dispersion that may be purified by known techniques, for example by dialysis.

Moreover, the three alternative embodiments described above also apply to the yttrium europium vanadate dispersions. That is to say it is possible to use a vanadate dispersion in which a rare-earth phosphate or a silica-based compound is present on the surface of the vanadate particles. Likewise, these particles may furthermore have, on the surface, an organosiloxane-type polymeric compound. The vanadate dispersions according to these alternative embodiments may be obtained by using methods of the same type as those described with regard to the phosphate dispersions, that is to say by addition of a polyphosphate and a rare-earth salt, or a silicate, to an initial vanadate dispersion, or addition of an organosilane-type compound to a dispersion pretreated with a silicate.

The specific dispersion based on phosphate and vanadate particles that has just been described has the property of being transparent and of emitting in the white when it is exposed to photon excitation with a wavelength of at most 380 nm, for example 254 nm.

The transparent luminescent material according to the second embodiment may be obtained by depositing this specific dispersion on the substrate in the manner described above.

The use of a specific dispersion of phosphates and vanadates according to the second or third alternative embodiment mentioned above and/or the use of just a drying operation or a drying operation followed by a low-temperature heat treatment after deposition of the dispersions on the substrate will result in a material whose phosphate particles have at least one of the characteristics described above, namely a rhabdophane structure and the presence, on the surface, of a rare-earth phosphate or a silica-based compound.

Finally, it should be noted that the materials of the invention may have a high volume fraction (relative to the volume occupied by the particles over the entire volume of the material or of the layer in a composite), that is to say it is at least 40%, more particularly at least 50% and even more particularly at least 55%.

Lastly, the invention relates to a luminescent system that comprises a material of the type described above according to the first or second embodiment and also an excitation source, which may be a UV photon source, such as a UV diode, or else an excitation of the Hg, rare gas or X-ray type.

The system may be used as transparent wall illumination device, as illuminating glazing or as another illumination device, especially in the case of the material emitting in the white. It may also be used as a diode emitting in the white under UV excitation.

Examples will now be given.

### EXAMPLE 1

This example relates to a transparent aqueous colloidal dispersion of lanthanum phosphate doped by cerium Ce3+ or terbium Tb³⁺ ions.

An aqueous lanthanide chloride solution (282.7 mg of LaCl₃.6H₂O at 353.35 g/mol, 319.1 mg of CeCl₃.6H₂O at 354.56 g/mol and 112.0 mg of TbCl₃.6H₂O at 373.37 g/mol dispersed in 20 ml of demineralized water) was mixed, with stirring, into a 0.1M sodium tripolyphosphate solution (735.8 mg at 367.9 g/mol in 20 ml of demineralized water). The clear solution obtained was taken to reflux for 3 h. After the reaction, the dispersion obtained was centrifuged at 11 000 rpm for 5 minutes and then washed with demineralized water. After washing, 2 ml of a 0.1M sodium hexametaphosphate solution (267.4 mg, MW=1337 g/mol) were added. The colloidal dispersion was then dialyzed for 24 h in demineralized water (15-kD membrane).

The colloidal dispersion obtained was stable and luminescent. It could be concentrated under mild conditions (40° C., low vacuum) up to 1 mol/l (about 250 g/l).

The transmission of the dispersion for a thickness of one micron was 98.2%.

Crystallized nanoparticles of LnPO₄.0.5H₂O (rhabdophane) were observed by X-ray diffraction, the mean coherence length of the crystal domains being 5 nm.

Well-dispersed nanoparticles with a size of around 5 nm, the standard deviation being 3 nm, were observed by transmission electron microscopy.

The mean hydrodynamic diameter measured by dynamic light scattering was 13 nm, the standard deviation being 4 nm.

The phosphorus/lanthanide molar ratio, determined by microanalysis on washed specimens, was about 1.8.

Under UV excitation (272 nm), the colloids exhibited luminescence in the green, characteristic of Tb³⁺ ions. The CIE coordinates were X=0.34 and Y=0.58 under excitation at 272 nm.

The luminescence quantum yield, defined as the ratio of the number of photons emitted by the cerium and terbium ions to the number of photons absorbed by the cerium, was about 40%.

### EXAMPLE 2

This example relates to a transparent aqueous colloidal dispersion of lanthanum phosphate doped by cerium Ce³⁺ ions.

494.7 mg of a 353.35 g/mol LaCl₃.6H₂O solution and 212.7 mg of a 354.56 g/mol CeCl₃.6H₂O solution, dispersed in 20 ml of demineralized water, were mixed, with stirring, into a 0.1M sodium tripolyphosphate solution (735.8 mg at 367.9 g/mol in 20 ml of demineralized water). The clear solution obtained was taken to reflux for 3 h. At the end of the reaction, the dispersion obtained was centrifuged at 11 000 rpm for 5 minutes and then washed with demineralized water. After washing, 2 ml of a 0.1M sodium hexametaphosphate solution (267.4 mg, MW=1337 g/mol) were added. The colloidal dispersion was then dialyzed for 24 h in demineralized water (15-kD membrane).

The colloidal dispersion obtained was stable and luminescent. It could be concentrated under mild conditions (40° C., low vacuum) up to 1 mol/l (about 250 g/l).

The transmission of the dispersion for a thickness of one micron was 98.2%.

Crystallized nanoparticles of LnPO₄.0.5H₂O (rhabdophane) were observed by X-ray diffraction, the mean coherence length of the crystal domains being 5 nm.

Well-dispersed nanoparticles with a size of around 5 nm, the standard deviation being 3 nm, were observed by transmission electron microscopy.

The mean hydrodynamic diameter measured by dynamic light scattering was 13 nm, the standard deviation being 4 nm.

The phosphorus/lanthanide molar ratio, determined by microanalysis on washed specimens, was about 1.8.

Under UV excitation (272 nm), the colloids exhibited luminescence in the violet visible-UV, characteristic of Ce³⁺ ions. The CIE coordinates were X=0.17 and Y=0.01 under excitation at 272 nm.

The luminescence quantum yield, defined as the ratio of the number of photons emitted by the cerium and lanthanum ions to the number of-photons absorbed by the cerium, was about 70%, about 15% of the luminescence being in the visible (>380 nm)

### EXAMPLE 3

This example relates to a transparent aqueous colloidal dispersion of lanthanum phosphate doped by cerium Ce³⁺ and terbium Tb³⁺ ions and according to the first alternative embodiment. The particles of the dispersion were coated with an LaPO₄ layer.

The colloidal dispersion of Example 1 was adjusted to a rare-earth concentration of 50 mM. Added to 20 ml of this suspension were 20 ml of a 100 mM sodium tripolyphosphate solution (735.8 mg at 367.9 g/mol in 20 ml of demineralized water). The mixture was heated to 60° C. with stirring. Next, 10 ml of a lanthanum chloride solution (353.35 mg of LaCl₃.6H₂O at 353.35 g/mol in 10 ml of deionized water) were very slowly added, drop by drop. At the end of the addition, the mixture was heated for 3 h at 90° C. and then cooled. The mixture was dialyzed for 24 hours in demineralized water (15-kD membrane). Next, 2 ml of a 0.1M sodium hexametaphosphate solution (267.4 mg, MW=1337 g/mol) were added. Next, the colloid was redialyzed for 24 hours in demineralized water (15-kD membrane). The dispersion obtained was able to be concentrated in terms of rare earths up to 1M (250 g/l).

The transmission of the dispersion for a thickness of one micron was 98.0%.

The existence of an LaPO₄ layer on the surface of the particles stabilizes the oxidation state 3 of the cerium with respect to an oxidizing treatment. This was apparent in the following test: 0.26 ml of 0.1M NaOH and 100 ul of 1.5% H₂O₂ were added per 1 ml of 15 mM colloidal dispersion according to Example 1 and 15 mM colloidal dispersion according to Example 3.

In the absence of the LaPO₄ layer (Example 1), a proportion (>25%) of the Ce³⁺ ions was converted to Ce⁴⁺ ions. The existence of Ce⁴⁺ ions is conventionally demonstrated by the appearance of a yellow coloration, that is to say by a strong absorption by the colloid in the blue (for example, absorbance of 0.2 at 400 nm).

In the case of Example 3 with an LaPO₄ layer, no oxidation of the Ce was visible (absorbance <0.05 at 400 nm).

### EXAMPLE 4

This example relates to the production of a luminescent material according to the invention emitting in the green.

The colloidal dispersion of Example 3 (1 ml at 40 g/l) was mixed with a tetramethylammonium silicate solution (1 ml of a commercial solution containing 15 wt % silica). The mixture was deposited on a substrate by spin coating (at 2000 rpm for 60 s). The film was then dried for 5 minutes at 60° C. in an oven. Five successive layers were deposited. A final drying operation for 1 h at 100° C. was carried out.

A transparent film luminescent to the eye under UV excitation was obtained. The transmission of the film for a thickness of one micron was 99.5%.

Under excitation at 272 nm, the material emitted partly in the green, with the following CIE coordinates: X=0.34 and Y=0.58.

### EXAMPLE 5

This example relates to the production of a transparent dispersion emitting in the white.

A) Preparation of a transparent aqueous colloidal dispersion of yttrium vanadate doped by europium Eu³⁺ ions

The entire synthesis was carried out in water, at a temperature of 60° C.

First, an insoluble citrate complex was formed by mixing an aqueous yttrium europium nitrate solution (689.3 mg of Y(NO₃)₃ at 383 g/mol and 89.2 mg of Eu(NO₃)₃ at 446 g/mol in 20 ml of demineralized water) with an aqueous sodium citrate Na₃C₆O₇H₅ solution (441.3 mg at 294 g/mol in 15 ml of demineralized water). The Eu/Y molar ratio was 10/90 and the sodium citrate/(Y+Eu) ratio was 0.75/1.

Next, an aqueous Na₃VO₄ solution of 12.6 pH was prepared (182.9 mg of Na₃VO₄ at 121.93 g/mol in 15 ml of demineralized water). The addition of this solution to the previous mixture, with stirring, caused the precipitate to dissolve for a V/(Y+Eu) molar ratio of 0.5/1. The particle formation reaction was carried out for a V/(Y+Eu) molar ratio of 0.75/1.

After 30 minutes of reaction at 60° C., the heating was stopped. 50 ml of colloidal dispersion with a pH of 8.7 were obtained. The suspension obtained was then dialyzed (15-kD membrane) in water at neutral pH. After dialysis, the pH of the colloidal dispersion was 7.7 and the concentration was of the order of 10⁻² mol/l.

Next, the dispersion was evaporated to dryness under mild conditions (40° C., low vacuum). The powder then obtained was easily redispersed in 1 ml of water, making it possible to obtain colloidal yttrium vanadate dispersions that were transparent and highly concentrated (400 g/l).

The transmission of the dispersion for a thickness of one micron was 97.7%.

Crystallized YVO₄ nanoparticles, (with a zircon structure) were observed by X-ray diffraction, the mean coherence length of the crystal domains being 8 nm.

Well-dispersed nanoparticles with a size of about 8 nm were observed by transmission electron microscopy, the standard deviation being 3 nm.

The mean hydrodynamic diameter measured by dynamic light scattering was 10 nm, the standard deviation being 3 nm.

The citrate/yttrium molar ratio, measured by microanalysis on washed specimens, was about 0.1.

Under UV excitation (280 nm), the colloids exhibited luminescence in the red, characteristic of Eu³⁺ ions (emission peak at 617 nm). The CIE coordinates were X=0.66 and Y=0.34 under excitation at 280 nm.

The luminescence quantum yield, defined as the ratio of the number of photons emitted by the europium ions to the number of photons absorbed by the vanadate groups, was about 15%.

B) Preparation of the Mixed Dispersion

The colloidal dispersion luminescent in the red, as obtained above at 40 g/l (0.45 ml), the colloidal dispersion luminescent in the green of Example 4 at 45 g/l (2.1 ml) and the dispersion luminescent in the violet of Example 2 at 70 g/l (7 ml) were mixed together with concentrated tetramethylammonium silicate (1.1 ml at [Si]=0.2M).

The transmission of the dispersion for a thickness of one micron was 97%.

The colloidal dispersion obtained was stable and luminesced in the white under UV excitation at 254 nm. The CIE coordinates of the mixture were X=0.35 and Y=0.35 under excitation at 254 nm.

### EXAMPLE 6

This example relates to a transparent material luminescent in the white.

The dispersion of Example 5 was deposited by spin coating (2000 rpm, 1 minute) on a glass slide. The film was dried for 2 h at 50° C. Several successive layers were possible (for example three) and the final thickness of the film was 500 nm. The transmission of the film for a thickness of one micron was 99.5%. The thin layers obtained were transparent, homogeneous (no cracking) and adhered well to the substrate. The film was luminescent, with white luminescence under UV excitation at 254 nm. The CIE coordinates were X=0.35 and Y=0.35.

### EXAMPLE 7

This example relates to an organic dispersion of LaPO₄ particles coated with a layer of silicate and of functionalized silane.

A commercial sodium silicate solution of 24 wt % SiO₂ and 8 wt % Na₂O composition was diluted to 1/8. Added to 50 ml of the solution obtained were 50 ml of a transparent colloidal solution of LaPO₄ doped with Ce and Tb according to Example 3, with a concentration of 0.05 mol/l. The mixture obtained was clear and its pH was 11. After 18 hours of stirring at room temperature, the solution was dialyzed (15-kD membrane). The final pH of the silicate-coated and dialyzed colloidal dispersion was 9.

Next, a mixture of 300 ml of ethanol and 1.421 mg of 3-(trimethoxysilyl)propyl methacrylate (TPM: C₁₀H₂₀O₅Si; M=248.35 g/mol) was added drop by drop to 100 ml of this silicate-coated lanthanum phosphate colloidal dispersion (0.01 mol/l; pH=9). The TPM/La ratio was 5.

The resulting mixture was then heated to reflux for 12 hours. After this treatment, the water of the reaction mixture was removed by azeotropic distillation with 400 ml of 1-propanol.

The transmission of the dispersion for a thickness of one micron was 99.1%.

### EXAMPLE 8

This example relates to a transparent aqueous colloidal dispersion of lanthanum phosphate.

An aqueous lanthanum chloride solution (706.7 mg of LaCl₃.6H₂O at 353.35 g/l dispersed in 20 ml of demineralized water) was mixed with stirring into a 0.1M sodium tripolyphosphate solution (735.8 mg at 367.9 g/mol in 20 ml of demineralized water). The clear solution obtained was taken to reflux for 3 h. After the reaction, the dispersion obtained was centrifuged (at 11 000 rpm for 5 minutes) and then washed with demineralized water. After washing, 2 ml of a 0.1M solution of sodium polyphosphate (267.4 mg, MW=1337) were added. The colloid was then dialyzed for 24 h in demineralized water (15-kD membrane).

The colloidal dispersion obtained was stable.

Crystallized nanoparticles of LaPO₄.0.5H₂O (rhabdophane) were observed by X-ray diffraction, the mean coherence length of the crystal domains being 5 nm.

Well-dispersed nanoparticles with a size of the order of 5 nm were observed by transmission electron microscopy, the standard deviation being 3 nm.

The mean hydrodynamic diameter measured by dynamic light scattering was 13 nm, the standard deviation being 4 nm.

The phosphorus/lanthanide molar ratio obtained by microanalysis on washed specimens was 1.8.

Using ³¹P MAS NMR at 15 kHz on a particle powder, the peak corresponding to the constituent lanthanum orthophosphate of the nanoparticles was observed at −3.2 ppm, and those assignable to the surface polyphosphate species at −12.0 and −20.5 ppm. These chemical shifts are given with respect to 85% H₃PO₄.

The width of these polyphosphate peaks suggest the presence of a polyphosphate on the surface of the particles, the polyphosphate being bonded to the particles, probably by complexation and in the form of the phosphate anion.

### EXAMPLE 9

This example relates to a transparent aqueous colloidal dispersion of lanthanum phosphate doped by europium Eu³⁺ ions.

565.4 mg of an LaCl₃.6H₂O solution at 353.35 g/mol and 146.6 mg of an EuCl₃.6H₂O solution at 366.4 g/mol, these being dispersed in 20 ml of demineralized water, were mixed with stirring into a 0.1M solution of sodium tripolyphosphate (735.8 mg at 367.9 g/mol in 20 ml of demineralized water). The clear solution obtained was taken to reflux for 3 h. At the end of the reaction, the dispersion obtained was centrifuged at 11 000 rpm for 5 minutes and then washed with demineralized water. After washing, 2 ml of a 0.1M sodium hexametaphosphate solution (267.4 mg, MW=1337 g/mol) were added. The colloidal dispersion was then dialyzed for 24 h in demineralized water (15-kD membrane).

The colloidal dispersion obtained was stable and luminescent. It was able to be concentrated under mild conditions (40° C., low vacuum) up to 1 mol/l (about 250 g/1).

Crystallized LnPO₄.0.5H₂O (rhabdophane) nanoparticles were observed by X-ray diffraction, the mean coherence length of the crystal domains being 5 nm.

Well-dispersed nanoparticles with a size of around 5 nm were observed by transmission electron microscopy, the standard deviation being 3 nm.

The mean hydrodynamic diameter measured by dynamic light scattering was 13 nm, the standard deviation being 4 nm.

The phosphorus/lanthanide molar ratio obtained by microanalysis on washed specimens was about 1.8.

Under UV excitation (272 nm), the colloids exhibited luminescence in the red, characteristic of Eu³⁺ ions.

1-27. (canceled)

28. A colloidal dispersion, comprising particles of a rare-earth (Ln) phosphate of rhabdophane structure and a polyphosphate.

29. The dispersion as claimed in claim 28, wherein the particles have a P/Ln molar ratio greater than 1, optionally between 1.1 and 2.

30. The dispersion as claimed in claim 28, wherein the particles have a mean size of at most 20 nm.

31. The dispersion as claimed in claim 28, wherein the rare-earth phosphate is a lanthanum cerium phosphate or a lanthanum cerium terbium phosphate.

32. The dispersion as claimed in claim 28, wherein the polyphosphate is a tripolyphosphate, optionally an alkali metal tripolyphosphate, or the corresponding anionic form.

33. The dispersion as claimed in claim 28, wherein the particles of a rare-earth (Ln) phosphate are particles of phosphates of at least two rare earths (Ln, Ln′) and a rare-earth (Ln) phosphate on the surface of the particles.

34. The dispersion as claimed in claim 28, further comprising a silica-based compound on the surface of the rare-earth phosphate particles.

35. The dispersion as claimed in claim 28, further comprising an organosiloxane-type polymeric compound on the surface of the rare-earth phosphate particles.

36. The dispersion as claimed in claim 28, wherein the particles of a rare-earth (Ln) phosphate are lanthanum cerium phosphate particles or lanthanum cerium terbium phosphate particles said dispersion further comprising yttrium europium vanadate particles.

37. A method of producing a dispersion as defined in claim 28, comprising the following steps:
a) forming a mixture comprising at least one rare-earth salt and a polyphosphate in quantities such that the P/Ln ratio is at least 3;
b) heating the mixture obtained at step a); and
c) removing the residual salts from the mixture obtained at step b) in order to obtain said dispersion.

38. The method as claimed in claim 37, wherein, at step c), the mixture obtained at step b) is centrifuged to remove the residual salts, and the product resulting from the centrifugation is washed and redispersed in water.

39. The method of producing a dispersion as defined in claim 33, comprising the following steps:
a) forming a mixture comprising at least one rare-earth salt and a polyphosphate in quantities such that the P/Ln ratio is at least 3;
b) heating the mixture obtained at step a);
c) removing the residual salts of the mixture obtained at step b)to obtain a dispresion;
d) adding a polyphosphate to the dispersion obtained at step c);
e) heating the mixture obtained at step d);
f) adding a rare-earth (Ln) salt to the mixture obtained at step e) in quantities such that the P/Ln molar ratio is at least 3, and heating the mixture thus obtained; and
g) removing the residual salts of the mixture obtained at step f) in order to recover the dispersion.

40. The method of producing a dispersion as defined in claim 34, comprising the following steps:
a) forming a mixture comprising at least one rare-earth salt and a polyphosphate in quantities such that the P/Ln ratio is at least 3;
b) heating the mixture obtained at step a);
c) removing the residual salts of the mixture obtained at step b) to obtain a dispresion;
d) adding a silicateate to the dispersion obtained at the end of step c);
e) the mixture thus obtained at step d) undergoes a maturing step; and
f) removing the residual salts of the mixture obtained at step e) in order to recover the dispersion.

41. The method of producing a dispersion as defined in claim 35, comprising the following steps:
a) forming a mixture comprising at least one rare-earth salt and a polyphosphate in quantities such that the P/Ln ratio is at least 3;
b) heating the mixture obtained at step a);
c) removing the residual salts of the mixture obtained at step b)to obtain a dispresion;
d) adding a silicateate to the dispersion obtained at the end of step c);
e) the mixture thus obtained at step d) undergoes a maturing step; and
f) removing the residual salts of the mixture obtained at step e) in order to recover a dispersion;
g) adding an organosilane to the dispersion obtained at the previous step;
h) the mixture thus obtained at step g) undergoes a maturing step; and
i) recovering the dispersion from the product obtained at step h).

42. A transparent luminescent material based on particles of a rare-earth (Ln) phosphate, said material having a P/Ln molar ratio greater than 1.

43. The material as claimed in claim 42, comprising lanthanum cerium phosphate particles and lanthanum cerium terbium phosphate particles.

44. A transparent luminescent material, comprising nanoparticles of compounds of vanadates, rare-earth phosphates, tungstates or rare-earth oxides and capable of emitting, when it is subjected to photon excitation with a wavelength of at most 380 nm, a white light whose trichromatic coordinates lie within the following polyhedron in the CIE chromaticity diagram: (x=0. 16; y=0.10); (x=0.16; y=0.4); (x=0.51; y=0.29); (x=0.45; y=0.42).

45. The material as claimed in claim 43, comprising lanthanum cerium phosphate particles, lanthanum cerium terbium phosphate particles and yttrium europium vanadate particles.

46. The material as claimed in claim 44, further comprising a polyphosphate.

47. The material as claimed in claim 44, having a P/Ln molar ratio greater than 1, optionally between 1.1 and 2.

48. The material as claimed in claim 44, further comprising lanthanum phosphate on the surface of the phosphate particles.

49. The material as claimed in claim 44, wherein the particles further comprise silica on the surface.

50. The material as claimed in claim 43, being capable of emitting, when it is exposed to the aforementioned excitation, a white light whose trichromatic coordinates lie within the polyhedron defined by the following points: (x=0.20; y=0.15); (x=0.20; y=0.30); (x=0.49; y=0.32); (x=0.45; y=0.42).

51. The material as claimed in claim 43 being capable of emitting, when it is exposed to the aforementioned excitation, a white light whose trichromatic coordinates lie within the polyhedron defined by the following points: (x=0.22; y=0.18); (x=0.22; y=0.31); (x=0.47; y=0.49); (x=0.45; y=0.42).

52. The material as claimed in claim 42, wherein the particles have a mean size of at most 20 nm.

53. The material as claimed in claim 42, further comprising a substrate and a layer on this substrate, said layer containing the aforementioned particles.

54. A luminescent system, comprising a material as defined in claim 42 and an excitation source.
